(19) United States
(12) Patent Application Publication
(10) Pub. No.: US 2022/0281293 A1
(43) Pub. Date: Sep. 8, 2022

(54) BLOWER AND FILTER DEVICE

(71) Applicant: DENSO CORPORATION, Kariya-city (JP)

(72) Inventor: Yoshihiro SUZUKI, Kariya-city (JP)

(21) Appl. No.: 17/751,151

(22) Filed: May 23, 2022

Related U.S. Application Data
(63) Continuation of application No. PCT/JP2020/038774, filed on Oct. 14, 2020.

(30) Foreign Application Priority Data
Nov. 27, 2019 (JP) 2019-214230

(51) Int. Cl. B60H 3/06; F04D 29/70

(52) U.S. Cl. CPC B60H 3/0608; F04D 29/701; B01D 46/521

(57) ABSTRACT

A blower includes an air introduction box, a casing, an impeller, a filter medium, a frame body, a first partition plate and a second partition plate. The filter medium captures a foreign matter contained in a first air and a second air flowing from the air introduction box to the impeller. The frame body houses the filter medium and is installed in a filter installation portion upstream of the impeller. The first partition plate is fixed to the frame body and divides a space upstream of the filter medium into a plurality of regions. The second partition plate is fixed to the frame body and divides a space downstream of the filter medium into a plurality of regions. The filter medium is interposed between the first partition plate and the second partition plate.

### CROSS REFERENCE TO RELATED APPLICATION

The present application is a continuation application of International Patent Application No. PCT/JP2020/038774 filed on Oct. 14, 2020, which designated the U.S. and claims the benefit of priority from Japanese Patent Application No. 2019-214230 filed on Nov. 27, 2019. The entire disclosures of all of the above applications are incorporated herein by reference.

### TECHNICAL FIELD

The present disclosure relates to a blower and a filter device installed in the blower.

### BACKGROUND

A blower includes a filter for capturing a foreign matter contained in air introduced from an outside air introduction port and an inside air introduction port of an air introduction box.

### SUMMARY

A blower configured to simultaneously suck in and separately blow out a first air and a second air, the blower includes:

an air introduction box having a first introduction port into which the first air is introduced and a second introduction port into which the second air is introduced;

a casing that forms a ventilation path through which air flows together with the air introduction box;

an impeller housed in the casing to suck in the first air and the second air introduced into the air introduction box and blow out to a first air passage and a second air passage downstream of the impeller;

a filter medium configured to capture a foreign matter contained in the first air and the second air flowing from the air introduction box to the impeller;

a frame body that houses the filter medium and is installed in a filter installation portion upstream of the impeller;

a first partition plate fixed to the frame body to divide a space upstream of the filter medium into a plurality of regions; and

a second partition plate fixed to the frame body to divide a space downstream of the filter medium into a plurality of regions, wherein the filter medium is interposed between the first partition plate and the second partition plate.

### BRIEF DESCRIPTION OF DRAWINGS

FIG. 1 is a cross-sectional view of a blower according to a first embodiment.

FIG. 2 is a perspective view showing a filter in the blower according to the first embodiment.

FIG. 3 is a plan view of the filter in a viewing direction III in FIG. 2.

FIG. 4 is an exploded perspective view of the filter of the first embodiment.

FIG. 5 is a view in which a filter medium of the filter of the first embodiment is assembled to a second frame.

FIG. 6 is a cross-sectional view taken along a line VI-VI of FIG. 3 in which a first frame and the second frame are fitted with each other.

FIG. 7 is a cross-sectional view showing another fitting between the first frame and the second frame.

FIG. 8 is a cross-sectional view showing another fitting between the first frame and the second frame.

FIG. 9 is an exploded perspective view of a filter according to a second embodiment.

FIG. 10 is a plan view of a filter according to a third embodiment.

FIG. 11 is an exploded perspective view of a filter according to a fourth embodiment.

FIG. 12 is a plan view of the filter according to the fourth embodiment.

FIG. 13 is a plan view of a filter according to a fifth embodiment.

FIG. 14 is a plan view of a filter according to a sixth embodiment.

FIG. 15 is a cross-sectional view taken along a line XV-XV of FIG. 14.

FIG. 16 is a cross-sectional view showing a filter according to a seventh embodiment.

FIG. 17 is a cross-sectional view showing a filter according to an eighth embodiment.

FIG. 18 is a cross-sectional view of a blower according to a ninth embodiment.

FIG. 19 is a plan view of a filter of the ninth embodiment.

FIG. 20 is an exploded perspective view of the filter in the blower according to the ninth embodiment.

### DESCRIPTION OF EMBODIMENTS

To begin with, examples of relevant techniques will be described.

Conventionally, a blower is applied to a vehicle air conditioner capable of setting an inside/outside air two-layer mode. The blower includes a filter for capturing a foreign matter contained in air introduced from an outside air introduction port and an inside air introduction port formed in an air introduction box. The filter is composed of a filter medium for dust removal (that is, a filter element) and partition plates attached to the filter medium. The space through which air flows in the filter is divided into three regions (that is, a right region, a central region, and a left region) by the partition plates. When the inside/outside air two-layer mode is set, outside air introduced from the outside air introduction port flows through the left and right regions of the filter, and inside air introduced from the inside air introduction port flows through the central region of the filter. The outside air that has passed through the left and right regions of the filter in the inside/outside air two-layer mode is blown out to a front windshield or the like from a defroster outlet in the vehicle interior via an air conditioning unit of an air conditioner.

However, the position of the partition plate is difficult to determine in the filter of the blower because the partition plate is directly attached to the filter medium. If the position of the partition plate deviates from the set position, the inside air and the outside air may be mixed in the inside/outside air two-layer mode. In this case, the front windshield may become cloudy. The present disclosure provides a blower and a filter device capable of reliably positioning a partition plate provided in a filter.

A blower configured to simultaneously suck in and separately blow out a first air and a second air, the blower includes:

an air introduction box having a first introduction port into which the first air is introduced and a second introduction port into which the second air is introduced;

a casing that forms a ventilation path through which air flows together with the air introduction box;

an impeller housed in the casing to suck in the first air and the second air introduced into the air introduction box and blow out to a first air passage and a second air passage downstream of the impeller;

a filter medium configured to capture a foreign matter contained in the first air and the second air flowing from the air introduction box to the impeller;

a frame body that houses the filter medium and is installed in a filter installation portion upstream of the impeller;

a first partition plate fixed to the frame body to divide a space upstream of the filter medium into a plurality of regions; and

a second partition plate fixed to the frame body to divide a space downstream of the filter medium into a plurality of regions, wherein the filter medium is interposed between the first partition plate and the second partition plate.

Accordingly, in the filter of the blower according to one aspect of the present disclosure, since the first partition plate and the second partition plate are fixed to the frame body, the partition plate can be easily and surely positioned. Therefore, the misalignment between the first partition plate and the second partition plate can be restricted. Therefore, the blower can suppress the mixing of the inside air and the outside air in the inside/outside air two-layer mode, and can restrict the front windshield from becoming cloudy.

In the present specification, “the filter medium is interposed between the first partition plate and the second partition plate” means that the filter medium, the second partition plate and the first partition plate overlap each other when viewed in the axial direction of the impeller. In addition, the filter medium, the second partition plate and the first partition plate may be positioned slightly offset from each other depending on the shape and the like of the filter medium. As a method for fixing the first partition plate and the second partition plate to the frame body, various methods such as welding, adhesion, fitting, integral molding, or connection via a hinge can be adopted.

Another aspect of the present disclosure relates to a filter device provided in a ventilation path through which a first air and a second air flow. The filter device includes a frame body, a filter medium, a first partition plate, and a second partition plate. The frame body constitutes the outer frame of the filter device. The filter medium is housed inside the frame body and captures foreign matter contained in the first air and the second air flowing through the ventilation path. The first partition plate is fixed to the frame body and divides the space upstream of the filter medium into a plurality of regions. The second partition plate is fixed to the frame body, and divides the space downstream of the filter medium into a plurality of regions. The filter medium is interposed between the first partition plate and the second partition plate.

The filter device according to another aspect of the present disclosure is also the same as the filter provided in the blower according to the one aspect of the present disclosure described above. Since the first partition plate and the second partition plate are fixed to the frame body, it is possible to easily and surely position the partition plates. Therefore, the misalignment between the first partition plate and the second partition plate can be restricted. Therefore, the filter device can suppress the mixing of the first air and the second air.

The reference numerals attached to the components and the like indicate an example of correspondence between the components and the like and specific components and the like described in embodiments to be described below.

Embodiments of the present disclosure will now be described with reference to the drawings. Parts that are identical or equivalent to each other in the following embodiments are assigned the same reference numerals and will not be described. In the three-dimensional coordinates described in each drawing, the arrow X means a width direction of a vehicle, the arrow Y means a front-rear direction of a vehicle, and the arrow Z means an up-down (vertical) direction.

### First Embodiment

A first embodiment is described below. A blower 1 of the present embodiment is applicable to an air conditioner for a vehicle, capable of setting an inside/outside air two-layer mode. The blower 1 simultaneously sucks in air outside the vehicle interior as a first air (hereinafter referred to as “outside air”) and air inside the vehicle interior as a second air (hereinafter referred to as “inside air”), and blows them out separately. The air blown out from the blower 1 (that is, outside air and inside air) is supplied to an air conditioning unit (not shown) included in the air conditioner. The air conditioning unit generates conditioned air by regulating the temperature and humidity of the air supplied from the blower 1, and blows the conditioned air from each outlet toward the front windshield of the vehicle, the upper body of the occupant, the feet of the occupant, and the like.

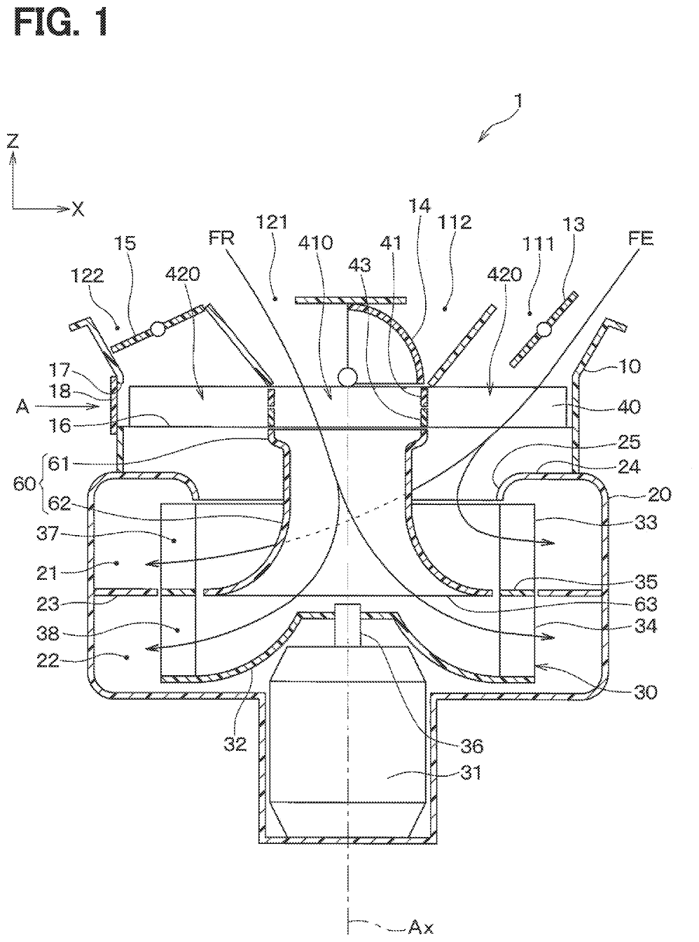

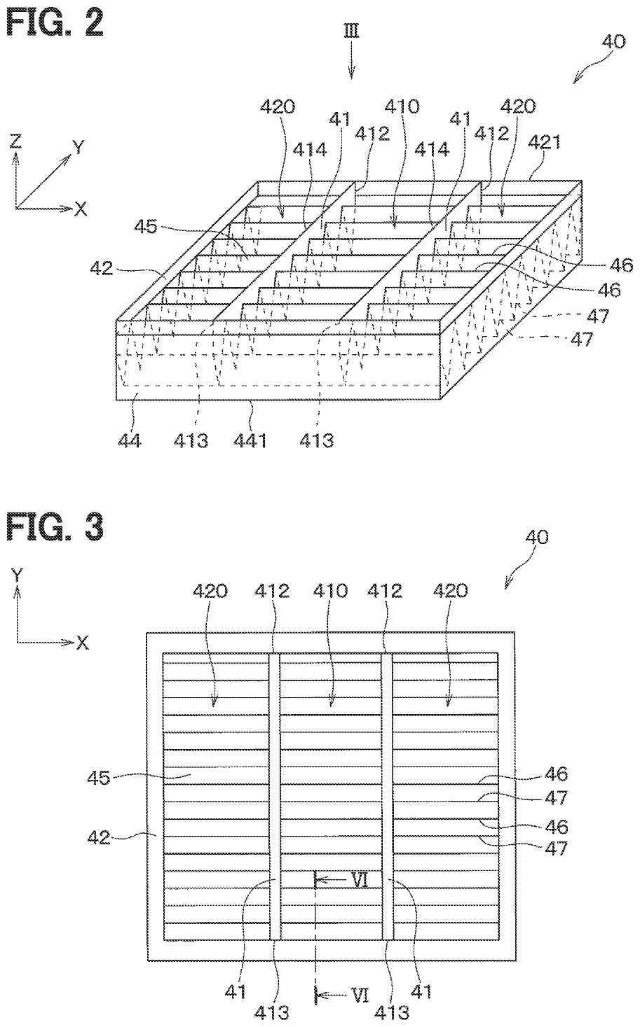

As shown in FIGS. 1 and 2, the blower 1 includes an air introduction box 10, a scroll casing 20, an impeller 30, a filter 40, and a separation cylinder 60.

In the following description, a radial direction of the impeller 30 represents a radial direction of a virtual circle drawn on a plane orthogonal to the rotation axis Ax of the impeller 30 around an arbitrary point on the rotation axis Ax of the impeller 30. A circumferential direction of the impeller 30 represents a circumferential direction of the virtual circle. It is assumed that the rotation axis Ax of the impeller 30 coincides with a shaft core of the impeller 30.

The air introduction box 10 is arranged on the upper side in the blower 1. The air introduction box 10 has a first outside air introduction port 111, a second outside air introduction port 112, a first inside air introduction port 121, and a second inside air introduction port 122. The first outside air introduction port 111 and the second outside air introduction port 112 are openings for introducing outside air into the air introduction box 10. The first inside air introduction port 121 and the second inside air introduction port 122 are openings for introducing inside air into the air introduction box 10. The first outside air introduction port 111 and the second outside air introduction port 112 correspond to a first introduction port into which the first air is introduced. Further, the first inside air introduction port 121 and the second inside air introduction port 122 correspond to a second introduction port into which the second air is introduced.

An outside air door 13, an inside/outside air door 14, an inside air door 15, and the like are provided in the air introduction box 10. The outside air door 13 opens and closes the first outside air introduction port 111. The inside/outside air door 14 selectively introduces air from the second outside air introduction port 112 and the first inside air introduction port 121. The inside air door 15 opens and closes the second inside air introduction port 122. Each of the outside air door 13 and the inside air door 15 is a butterfly door. The inside/outside air door 14 is a rotary door.

The outside air door 13 and the inside air door 15 may be composed of a door other than the butterfly door (for example, a rotary door). The inside/outside air door 14 may be composed of a door other than the rotary door (for example, a butterfly door).

The filter 40 is installed in the filter installation portion 16 provided in the air introduction box 10. The filter installation portion 16 is formed in the air introduction box 10 so that the filter 40 can be installed. The filter installation portion 16 is provided on the upstream side of the impeller 30. The outer wall of the air introduction box 10 has an opening 17 for attaching/detaching the filter 40 to/from the filter installation portion 16. The opening 17 is closed by the lid member 18. The lid member 18 is fixed to the outer wall of the air introduction box 10 by, for example, a screw or a snap fit.

As shown in FIGS. 2 to 5, the filter 40 is configured as a filter subassembly which is a combination of a first frame body 42 to which the first partition plate 41 is fixed, a second frame body 44 to which the second partition plate 43 is fixed, and a filter medium 45. The filter subassembly corresponds to a filter device of the present disclosure.

The first frame body 42 and the second frame body 44 surround the outside of the filter medium 45 and form an outer frame of the filter 40. In the air flow direction of the filter 40, the first frame body 42 is arranged on the upstream side, and the second frame body 44 is arranged on the downstream side. That is, the first frame body 42 is arranged to oppose the outside air introduction port 110 or the inside air introduction port 123, 124, and the second frame body 44 is arranged to oppose the impeller 30 or the separation cylinder 60. The first frame body 42 and the second frame body 44 are formed of, for example, resin, and are formed in a substantially rectangular shape when viewed from the upper side (in the axial direction Ax of the impeller 30).

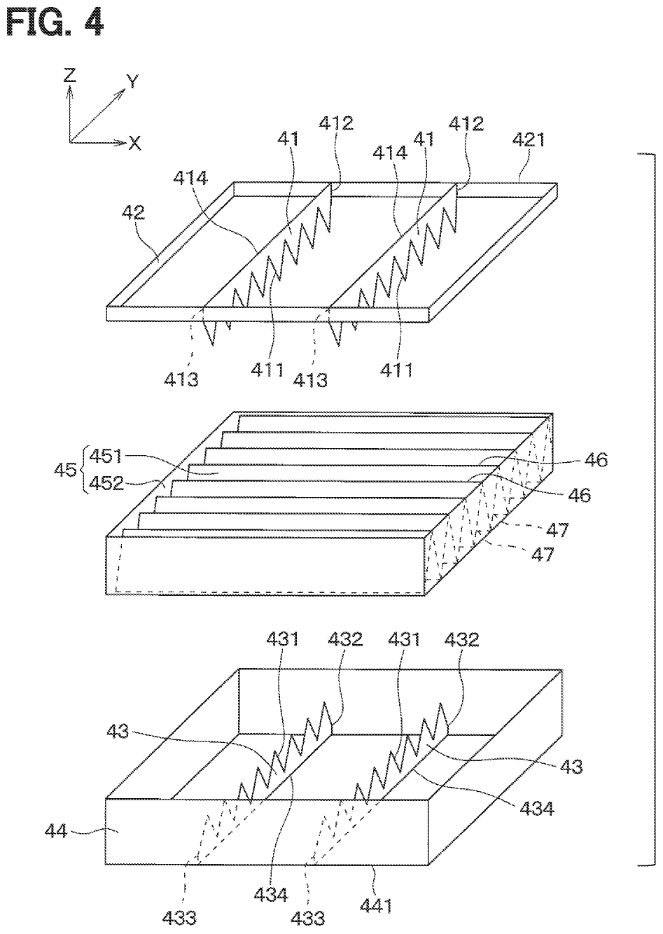

The filter medium 45 is housed inside the first frame body 42 and the second frame body 44. As shown in FIG. 4, the filter medium 45 integrally has a corrugated portion 451 and an outer edge portion 452. The corrugated portion 451 is formed by bending, for example, a non-woven fabric having a predetermined air permeability. Specifically, the corrugated portion 451 has a corrugated shape in which mountain portions and valley portions are alternately formed. The corrugated shape may be referred to as a jagged shape, a pleated shape, an accordion shape, or the like. In the present embodiment, the mountain ridge line 46 and the valley ridge line 47 formed in the corrugated portion 451 of the filter medium 45 are arranged in the front-rear direction of the vehicle and extend in the vehicle width direction. The outer edge portion 452 is fixed to the outer edge of the corrugated portion 451 and maintains the corrugated shape of the corrugated portion 451. The outer edge portion 452 may be made of the same material as the corrugated portion 451 or may be made of a resin or the like. The outer shape of the filter medium 45 is also formed in a substantially rectangular shape when viewed from the upper side (in the axial direction Ax of the impeller 30). The filter medium 45 captures foreign matter such as particles contained in the air flowing from the air introduction box 10 toward the impeller 30.

The first partition plate 41 is a plate-shaped member for dividing the space upstream of the filter medium 45 into a plurality of regions. In the present embodiment, two first partition plates 41 are arranged on the upstream side of the filter medium 45. The two first partition plates 41 are arranged substantially in parallel with a predetermined interval. Specifically, the two first partition plates 41 extend in a direction (i.e., in the vehicle front-rear direction) intersecting the extending direction of the mountain ridge line 46 and the valley ridge line 47 of the filter medium 45.

As shown in FIG. 4, the wavy portion 411 of the first partition plate 41 adjacent to the filter medium 45 has a corrugated shape (in other words, a jagged shape) corresponding to the corrugated shape of the filter medium 45. Therefore, the wavy portion 411 can enter each gap, e.g., the valley portion of the filter medium 45. As a result, the two first partition plates 41 divide the space upstream of the filter medium 45 into three regions.

Each of the two first partition plates 41 has end portions 412 and 413 in the longitudinal direction, which are fixed to the first frame body 42. Specifically, the two first partition plates 41 and the first frame body 42 are integrally molded by resin injection molding. The fixing method between the first partition plate 41 and the first frame body 42 is not limited to integral molding, and various methods such as welding, adhesion, fitting, or connection via a hinge can be adopted.

The upstream end of the first partition plate 41 is referred to as the first partition plate upper end. The upstream end of the first frame body 42 is referred to as a frame upper end 421. The first partition plate upper end 414 is arranged at the same position as the frame upper end 421, or is arranged adjacent to the filter medium 45 than the frame upper end 421 is.

The second partition plate 43 is a plate-shaped member for dividing the space downstream of the filter medium 45 into a plurality of regions. In the present embodiment, two second partition plates 43 are arranged on the downstream side of the filter medium 45. The two second partition plates 43 are arranged substantially in parallel with a predetermined interval. The two second partition plates 43 are provided at positions corresponding to the above-mentioned two first partition plates 41. Specifically, in the present embodiment, the second partition plate 43 and the first partition plate 41 are provided at positions to overlap each other when viewed from the axial direction Ax of the impeller 30. The two second partition plates 43 are provided so as to sandwich the filter medium 45 together with the two first partition plates 41. The second partition plate 43 and the first partition plate 41 may be provided at positions slightly offset from each other in the axial direction Ax of the impeller 30.

The wavy portion 431 of the second partition plate 43 adjacent to the filter medium 45 has a corrugated shape (in other words, a jagged shape) corresponding to the corrugated shape of the filter medium 45. Therefore, the wavy portion 431 can enter each gap, e.g., the mountain portion of the filter medium 45. As a result, the two second partition plates 43 divide the space downstream of the filter medium 45 into three regions.

Each of the two second partition plates 43 has end portions 432 and 433 in the longitudinal direction, which are fixed to the second frame body 44. Specifically, the two second partition plates 43 and the second frame body 44 are integrally molded by resin injection molding. The method of fixing the second partition plate 43 and the second frame body 44 is not limited to integral molding, and various methods such as welding, adhesion, fitting, or connection via a hinge can be adopted.

The downstream end of the second partition plate 43 is referred to as a second partition plate lower end 434. Further, the downstream end of the second frame body 44 is referred to as a frame lower end 441. The second partition plate lower end 434 is arranged at the same position as the frame lower end 441, or is arranged closer to the filter medium 45 than the frame lower end 441 is.

As shown in FIGS. 2 and 3, in the following description, of the spaces inside the first frame body 42 and the second frame body 44, the central region partitioned by the two first partition plates 41 and two second partition plates 43 is referred to as a central region 410. Further, of the spaces inside the first frame body 42 and the second frame body 44, the left and right region with respect to the central region 410 is referred to as a left and right region 420.

A method of assembling the filter 40 will be described.

First, as shown in FIG. 4, the first frame body 42 to which the first partition plate 41 is fixed, the second frame body 44 to which the second partition plate 43 is fixed, and the filter medium 45 are prepared for the method of assembling the filter 40.

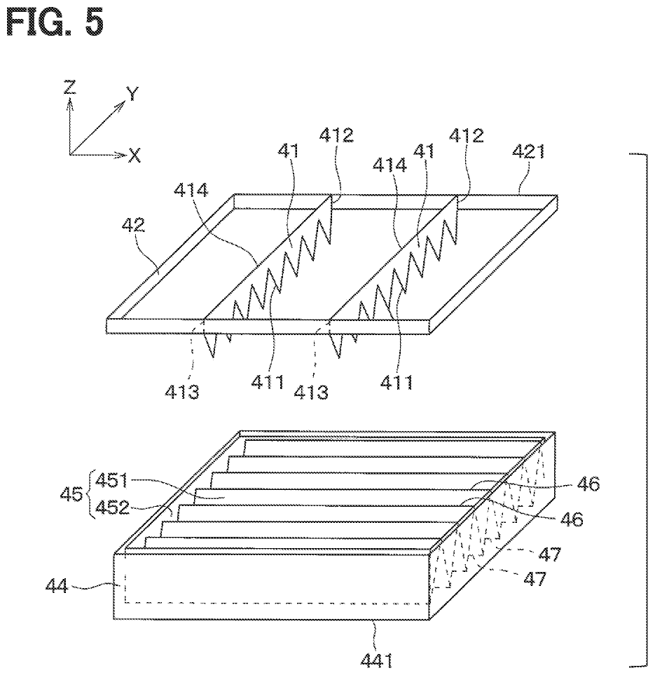

Next, as shown in FIG. 5, the filter medium 45 is assembled inside the second frame body 44. At this time, the corrugated shape of the filter medium 45 and the corrugated shape of the second partition plate 43 fixed to the second frame body 44 are matched. Then, the wavy portion 431 of the second partition plate 43 adjacent to the filter medium 45 is inserted into each gap, e.g., the mountain portion of the filter medium 45.

Subsequently, the first frame body 42 is assembled to the second frame body 44 and the filter medium 45 from the upper side. At this time, the corrugated shape of the filter medium 45 and the corrugated shape of the first partition plate 41 fixed to the first frame body 42 are matched. Then, the wavy portion 411 of the first partition plate 41 adjacent to the filter medium 45 is inserted into each gap, e.g., the valley portion of the filter medium 45. At the same time, the first frame body 42 and the second frame body 44 are fixed by fitting.

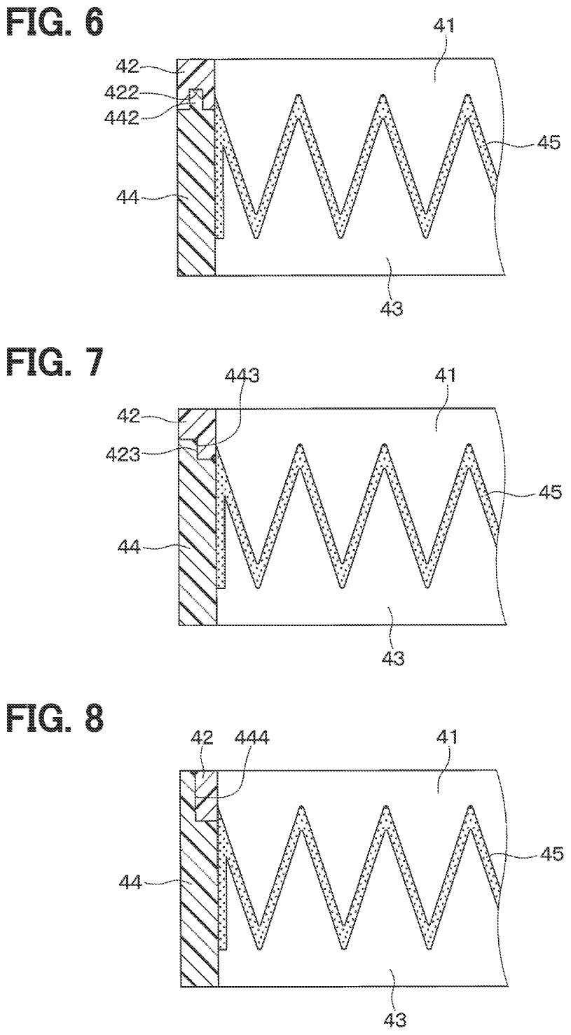

FIGS. 6 to 9 show examples of the fitting method between the first frame body 42 and the second frame body 44.

In the example shown in FIG. 6, a recess 422 is provided at the end of the first frame body 42 adjacent to the second frame body 44, and a convex portion 442 is provided at the end of the second frame body 44 adjacent to the first frame body 42. The first frame body 42 and the second frame body 44 are fixed by fitting the concave portion 422 of the first frame body 42 and the convex portion 442 of the second frame body 44.

In the example shown in FIG. 7, a step structure 423 is provided at the end of the first frame body 42 adjacent to the second frame body 44, and a step structure 443 is provided at the end of the second frame body 44 adjacent to the first frame body 42. The first frame body 42 and the second frame body 44 are fixed by fitting the step structure 423 of the first frame body 42 and the step structure 443 of the second frame body 44.

In the example shown in FIG. 8, a step structure 444 is provided at the end of the second frame body 44 adjacent to the first frame body 42, and the first frame body 42 is formed in a size that can be fitted inside the step structure 444 provided in the second frame body 44. Therefore, the first frame body 42 and the second frame body 44 are fixed by fitting the first frame body 42 to the step structure 444 of the second frame body 44.

As shown in FIGS. 6 to 8, the fitting of the first frame body 42 and the second frame body 44 restricts a relative movement of the first frame body 42 and the second frame body 44 in a direction intersecting an overlap direction in which the first frame body 42 and the second frame body 44 overlap with each other. The fitting method between the first frame body 42 and the second frame body 44 is not limited to those illustrated in FIGS. 6 to 9, and various methods can be adopted.

In this way, when the first frame body 42 to which the first partition plate 41 is fixed, the second frame body 44 to which the second partition plate 43 is fixed, and the filter medium 45 are assembled, the filter 40 shown in FIG. 2 and FIG. 3 is obtained.

As shown in FIG. 1, the air introduction box 10 of the blower 1 has an opening 17 for attaching/detaching the filter 40 to/from the filter installation portion 16. The opening 17 is closed by the lid member 18. When attaching/detaching the filter 40 to/from the filter installation portion 16, first, the lid member 18 is removed from the air introduction box 10. Next, the filter 40 is inserted through the opening 17 in the A direction in FIG. 1, and the filter 40 is attached to the filter installation portion 16. At that time, according to the filter 40 of the present embodiment, since the first partition plate 41 does not protrude from the first frame body 42 and the second partition plate 43 does not protrude from the second frame body 44, it is possible to restrict the first partition plate 41 or the second partition plate 43 from interfering with the wall around the periphery of the opening 17.

According to the filter 40 of the present embodiment, the first partition plate 41 or the second partition plate 43 can be restricted from interfering with the wall around the opening 17 when the filter 40 is removed from the filter installation portion 16.

In the blower 1, the scroll casing 20 is provided downstream side of the air introduction box 10. The scroll casing 20 and the air introduction box 10 form a ventilation path through which air flows. The air that has passed through the filter 40 flows into the ventilation path of the scroll casing 20. The impeller 30 is housed inside the scroll casing 20.

The impeller 30 is a centrifugal fan that is rotated by driving an electric motor. Specifically, the impeller 30 is composed of a sirocco fan. The impeller 30 is not limited to this, and may be composed of a radial fan, a turbo fan, or the like. When the impeller 30 is rotated by the drive of the electric motor 31, the impeller 30 sucks in air from one side in the axial direction Ax and blows out the sucked air in the direction away from the axial direction Ax.

The impeller 30 has a main plate 32, a plurality of first blades 33, a plurality of second blades 34, and a separation plate 35.

The main plate 32 is formed in a disk shape. A shaft 36 of the electric motor 31 is fixed to the center of the main plate 32. The second blades 34 are arranged with respect to the main plate 32. The first blades 33 are arranged to face the filter 40, and the separation plate 35 is disposed between the first blades 33 and the second blades 34.

The first blades 33 and the second blades 34 are arranged at a predetermined interval in the circumferential direction of the impeller 30. A first blade flow path 37 through which air flows is formed between the first blades 33. A second blade flow path 38 through which air flows is formed between the second blades 34.

The separation plate 35 connects the first blades 33 and the second blades 34. The separation plate 35 separates the first blade flow path 37 and the second blade flow path 38 from each other.

The scroll casing 20 forms ventilation passages 21 and 22 on the radially outer side of the impeller 30. A partition wall 23 is provided between the ventilation passages 21 and 22. The partition wall 23 is provided at a position corresponding to the separation plate 35 of the impeller 30. The partition wall 23 divides the ventilation passage on the radially outer side of the impeller 30 into a first ventilation passage 21 on one side in the axial direction Ax of the impeller 30 and a second ventilation passage 22 on the other side in the axial direction Ax of the impeller 30. The first ventilation passage 21 and the second ventilation passage 22 are configured to rectify the airflow radially blown from the impeller 30 into a flow in the circumferential direction of the impeller 30 and supply the airflow to an air conditioning unit (not shown).

One side of the scroll casing 20 in the axial direction Ax of the impeller 30 has a suction port forming portion 24 constituting the upper wall of the first ventilation passage 21. An annular bell mouth 25 for forming a suction port for air sucked into the impeller 30 is provided substantially in the center of the suction port forming portion 24. That is, the flow path inside the bell mouth 25 serves as a suction port for air sucked into the impeller 30. The bell mouth 25 is provided between the filter 40 and the impeller 30, and is shaped to have a cross section curved in an arc shape so that the air passing through the filter 40 smoothly flows to the suction port of the impeller 30.

The separation cylinder 60 is provided in the space inside the first blade 33 and the second blade 34 in the radial direction of the impeller 30 (hereinafter, simply referred to as “inside the impeller 30”). The separation cylinder 60 integrally has an air collecting portion 61 and a tubular portion 62. The air collecting portion 61 is arranged between the filter 40 and the bell mouth 25. The air collecting portion 61 is formed in a shape and size corresponding to the central region 410 of the filter 40. Although not shown, the air collecting portion 61 is formed in a substantially rectangular shape when viewed from the axial direction Ax of the impeller 30. The air collecting portion 61 is arranged so as to be in contact with or adjacent to the lower surface of the filter 40 at a position corresponding to the central region 410 of the filter 40. The air collecting portion 61 introduces the air that has passed through the central region 410 of the filter 40 into the flow path inside the tubular portion 62. That is, most of the air that has passed through the central region 410 of the filter 40 flows into the flow path inside the separation cylinder 60. On the other hand, most of the air that has passed through the left and right regions 420 of the filter 40 flows to the flow path outside the separation cylinder 60.

The tubular portion 62 is integrally formed with the air collecting portion 61 and is arranged inside the impeller 30. The tubular portion 62 extends in a cylindrical shape in the axial direction Ax of the impeller 30. The tubular portion 62 is formed in a flare shape that gradually expands radially outward as it approaches the air outlet portion 63. The outer edge of the tubular portion 62 adjacent to the air outlet portion 63 is provided at a position corresponding to the separation plate 35 of the impeller 30. As a result, the air flowing through the flow path inside the separation cylinder 60 flows to the second ventilation passage 22 via the second blade flow path 38 of the impeller 30. On the other hand, the air flowing through the flow path outside the separation cylinder 60 flows to the first ventilation passage 21 via the first blade flow path 37 of the impeller 30.

The blower 1 can be set to operate with air suction mode such as an inside/outside air two-layer mode in which the outside air and the inside air are simultaneously sucked and separately blown out, an outside air mode in which the outside air is sucked in and blown out, and an inside air mode in which the inside air is sucked in and blown out.

FIG. 1 shows a state in which the inside/outside air two-layer mode is set in the blower 1. At that time, the outside air door 13 is set to a position where the first outside air introduction port 111 is opened. The inside/outside air door 14 is set to a position where the first inside air introduction port 121 is communicated with the central region 410 of the filter 40, and the communication between the second outside air introduction port 112 and the central region 410 of the filter 40 is cut off. The inside air door 15 is set to a position where the second inside air introduction port 122 is closed. In this state, when the impeller 30 is rotated by the drive of the electric motor 31, the outside air is introduced from the first outside air introduction port 111 and the inside air is introduced from the first inside air introduction port 121.

As shown by the arrow FE in FIG. 1, the outside air introduced from the first outside air introduction port 111 passes through the left and right regions 420 of the filter 40, flows through the flow path outside the separation cylinder 60, and is sucked into the first blade flow path 37 of the impeller 30 so as to be blown out to the first ventilation passage 21.

On the other hand, as shown by the arrow FR in FIG. 1, the inside air introduced from the first inside air introduction port 121 passes through the central region 410 of the filter 40, flows through the flow path inside the separation cylinder 60, and is sucked into the second blade flow path 38 of the impeller 30 so as to be blown out to the second ventilation passage 22.

The outside air flowing through the first ventilation passage 21 and the inside air flowing through the second ventilation passage 22 are introduced into an air conditioning unit (not shown), adjusted to a desired temperature and humidity inside the air conditioning unit, and then is blown out from each outlet to the cabin. When the inside/outside air two-layer mode is set for the blower 1, the outside air flowing through the first ventilation passage 21 is mainly blown out to the windshield from the defroster outlet provided in the cabin.

Although not shown, in the blower 1, when the outside air mode is set, the outside air door 13, the inside/outside air door 14, and the inside air door 15 are displaced as follows. The outside air door 13 is set to a position where the first outside air introduction port 111 is opened. The inside/outside air door 14 is set to a position where the second outside air introduction port 112 is communicated with the central region 410 of the filter 40, and the communication between the first inside air introduction port 121 and the central region 410 of the filter 40 is cut off. The inside air door 15 is set to a position where the second inside air introduction port 122 is closed. When the impeller 30 rotates in this state, the outside air introduced from the first outside air introduction port 111 passes through the left and right regions 420 of the filter 40, flows through the flow path outside the separation cylinder 60, and is sucked into the first blade flow path 37 of the impeller 30 so as to be blown out to the first ventilation passage 21. Further, the outside air introduced from the second outside air introduction port 112 passes through the central region 410 of the filter 40, flows through the flow path inside the separation cylinder 60, and is sucked into the second blade flow path 38 of the impeller 30 so as to be blown out to the second ventilation passage 22.

Further, in the blower 1, when the inside air mode is set, the outside air door 13, the inside/outside air door 14, and the inside air door 15 are displaced as follows. The outside air door 13 is set to a position where the first outside air introduction port 111 is closed. The inside/outside air door 14 is set to a position where the first inside air introduction port 121 is communicated with the central region 410 of the filter 40, and the communication between the second outside air introduction port 112 and the central region 410 of the filter 40 is cut off. The inside air door 15 is set to a position where the second inside air introduction port 122 is opened. When the impeller 30 rotates in this state, the inside air introduced from the first internal air introduction port 121 passes through the central region 410 of the filter 40, flows through the flow path inside the separation cylinder 60, and is sucked into the second blade flow path 38 of the impeller 30 and blown out to the second ventilation passage 22. Further, the inside air introduced from the second inside air introduction port 122 flows through the flow path outside the separation cylinder 60 via the left and right regions 420 of the filter 40, and is sucked into the first blade flow path 37 of the impeller 30 and is blown out to the first ventilation passage 21.

The blower 1 of the first embodiment has the following effects.

(1) The filter 40 in the blower 1 of the first embodiment has the filter medium 45 interposed between the first partition plate 41 and the second partition plate 43. The first partition plate 41 is fixed to the first frame body 42, and the second partition plate 43 is fixed to the second frame body 44. This makes it possible to easily and reliably position the first partition plate 41 and the second partition plate 43. Therefore, the misalignment between the first partition plate 41 and the second partition plate 43 can be restricted. Therefore, this blower 1 can suppress the mixing of the inside air and the outside air in the inside/outside air two-layer mode, and can restrict the front windshield of the vehicle from becoming cloudy.

(2) In the filter 40 of the blower 1 of the first embodiment, the first partition plate upper end 414 is arranged at the same position as the frame upper end 421, or is located adjacent to the filter medium 45 than the frame upper end 421. Further, in the filter 40, the second partition plate lower end 434 is arranged at the same position as the frame lower end 441, or is located closer to the filter medium 45 than the frame lower end 441.

Accordingly, in the filter 40, the first partition plate upper end 414 does not protrude to the upstream side from the frame upper end 421, and the second partition plate lower end 434 does not protrude to the downstream side from the frame lower end 441. Therefore, when the filter 40 is attached to and detached from the filter installation portion 16 through the opening 17 provided in the outer wall of the air introduction box 10, the first partition plate 41 or the second partition plate 43 can be restricted from interfering with the wall around the opening 17. Therefore, the filter 40 can be easily attached/detached in the blower 1.

(3) In the filter 40 of the blower 1 of the first embodiment, the first frame body 42 and the first partition plate 41 are integrally formed by resin injection molding or the like, and the second frame body 44 and the second partition plate 43 are integrally formed by resin injection molding or the like. Accordingly, the manufacturing process can be simplified and the manufacturing cost can be reduced.

(4) In the filter 40 of the blower 1 of the first embodiment, the first frame body 42 and the second frame body 44 are fixed by fitting. The fitting of the first frame body 42 and the second frame body 44 restricts a relative movement of the first frame body 42 and the second frame body 44 in a direction intersecting the overlap direction in which the first frame body 42 and the second frame body 44 overlap each other. Accordingly, it is possible to easily assemble the first frame body 42, the second frame body 44, and the filter medium 45, and at the same time, the positional deviation between the first frame body 42 and the second frame body 44 can be restricted.

### Second Embodiment

A second embodiment will be described below. The second embodiment is a modification of the first embodiment, in which a part of the configuration of the filter 40 is modified. Since the other parts are the same as those of the first embodiment, only the parts different from the first embodiment will be described.

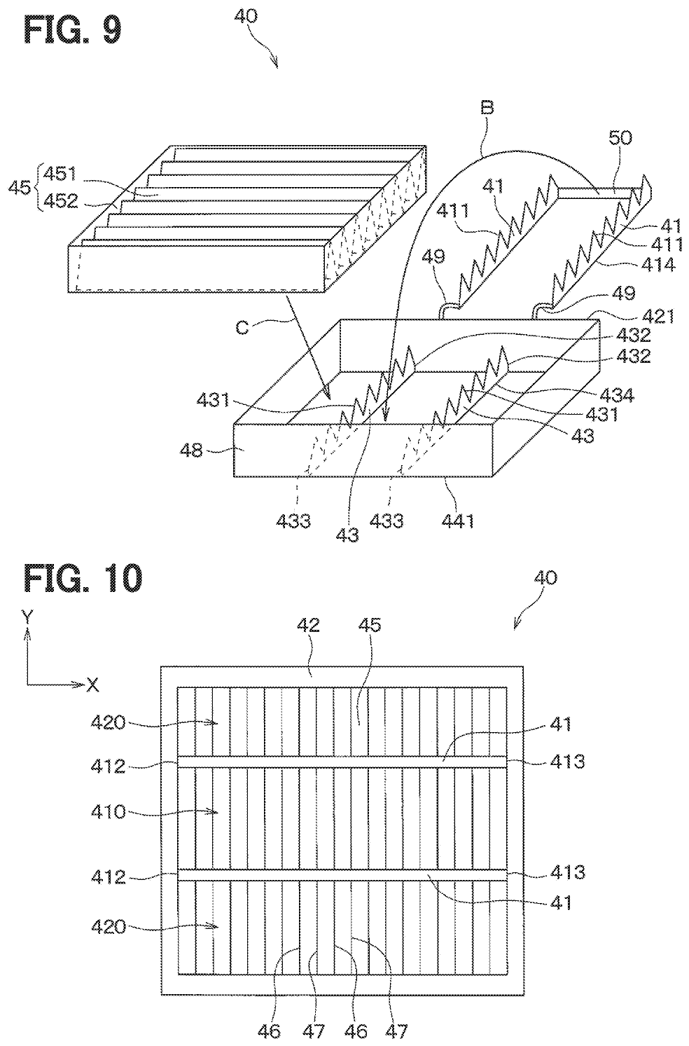

As shown in FIG. 9, the filter 40 of the second embodiment includes one frame body 48, two first partition plates 41, two second partition plates 43, and a filter medium 45. The frame body 48 surrounds the outside of the filter medium 45 and constitutes the outer frame of the filter 40. The frame body 48 is made of, for example, resin or the like, and is formed in a substantially rectangular shape when viewed from the upper side (that is, in the axial direction Ax of the impeller 30).

The first partition plate 41 and the frame body 48 are connected to each other via a hinge 49. The hinge 49 is formed of, for example, resin member that is easily elastically deformed. Therefore, the two first partition plates 41 can be moved as shown by the arrow direction B in FIG. 9. The two first partition plates 41 are connected with each other at the ends opposite to the hinge 49 by the connection plate 50. Therefore, the distance between the two first partition plates 41 is kept substantially constant from the hinge 49 to the connection plate 50.

The two second partition plates 43 are fixed to the frame body 48 as in the first embodiment at both end portions 432 and 433 in the longitudinal direction. The two second partition plates 43 are provided at positions corresponding to the two first partition plates 41. The filter medium 45 is interposed between the two second partition plates 43 and the two first partition plates 41. The second partition plate lower end 434 is arranged at the same position as the frame lower end 441, or is arranged closer to the filter medium 45 than the frame lower end 441 is.

The frame body 48, the hinge 49, the first partition plate 41, and the second partition plate 43 are integrally molded by resin injection molding. The method of fixing the frame body 48, the hinge 49, the first partition plate 41, and the second partition plate 43 is not limited to integral molding, but various methods such as welding, adhesion, and fitting can be adopted.

The method of assembling the filter 40 of the second embodiment will be described.

As for the method of assembling the filter 40, first, as shown by the arrow C in FIG. 9, the filter medium 45 is assembled inside the frame body 48 to which the second partition plate 43 is fixed. At this time, the corrugated shape of the second partition plate 43 fixed to the frame body 48 and the corrugated shape of the filter medium 45 are matched. Then, the wavy portion 431 of the second partition plate 43 adjacent to the filter medium 45 is inserted into each gap, e.g., the mountain portion of the filter medium 45.

Subsequently, as shown by the arrow B in FIG. 9, the first partition plate 41 is rotated by using the hinge 49, and the first partition plate 41 is put on the filter medium 45. At this time, the corrugated shape of the first partition plate 41 and the corrugated shape of the filter medium 45 are matched. Then, the wavy portion 411 of the first partition plate 41 adjacent to the filter medium 45 is inserted into each gap, e.g., the valley portion of the filter medium 45. At the same time, the connection plate 50 connecting the two first partition plates 41 and the frame body 48 are fixed. As the fixing method between the connection plate 50 and the frame body 48, various methods such as fitting or snap-fit can be adopted. When the connection plate 50 is fixed to the frame body 48, the first partition plate upper end 414 is arranged at the same position as the frame upper end 421, or is located closer to the filter medium 45 than the frame upper end 421.

The filter 40 of the blower 1 of the second embodiment has a configuration in which the first partition plate 41 and the frame body 48 are connected via the hinge 49. Accordingly, the number of parts can be reduced and the filter 40 can be easily assembled. Further, since the first partition plate 41 and the second partition plate 43 are fixed to one frame body 48, it is possible to restrict the positional shift between the first partition plate 41 and the second partition plate 43.

Also in the second embodiment, in the filter 40, with the first partition plate 41 covered on the filter medium 45, the first partition plate upper end 414 does not protrude to the upstream side from the frame upper end 421. The second partition plate lower end 434 does not protrude to the downstream side from the frame lower end 441. Therefore, when the filter 40 is attached to and detached from the filter installation portion 16 through the opening 17 provided in the outer wall of the air introduction box 10, the first partition plate 41 or the second partition plate 43 can be restricted from interfering with the wall around the opening 17. Therefore, the filter 40 can be easily attached/detached in the blower 1.

### Third to Fifth Embodiments

The third to fifth embodiments will be described.

In the first embodiment, as shown in FIG. 3, the filter medium 45 of the filter 40 has the mountain ridge line 46 and the valley ridge line 47 formed to extend in the vehicle width direction. Further, the first partition plate 41 and the second partition plate 43 extend in the vehicle front-rear direction intersecting the extending direction of the mountain ridge line 46 and the valley ridge line 47 formed in the filter medium 45.

In the third to fifth embodiments, the orientation of the filter 40 is changed with respect to the first embodiment. Since the other configuration is the same as the first embodiment, only the parts different from those of the first embodiment will be described.

### Third Embodiment

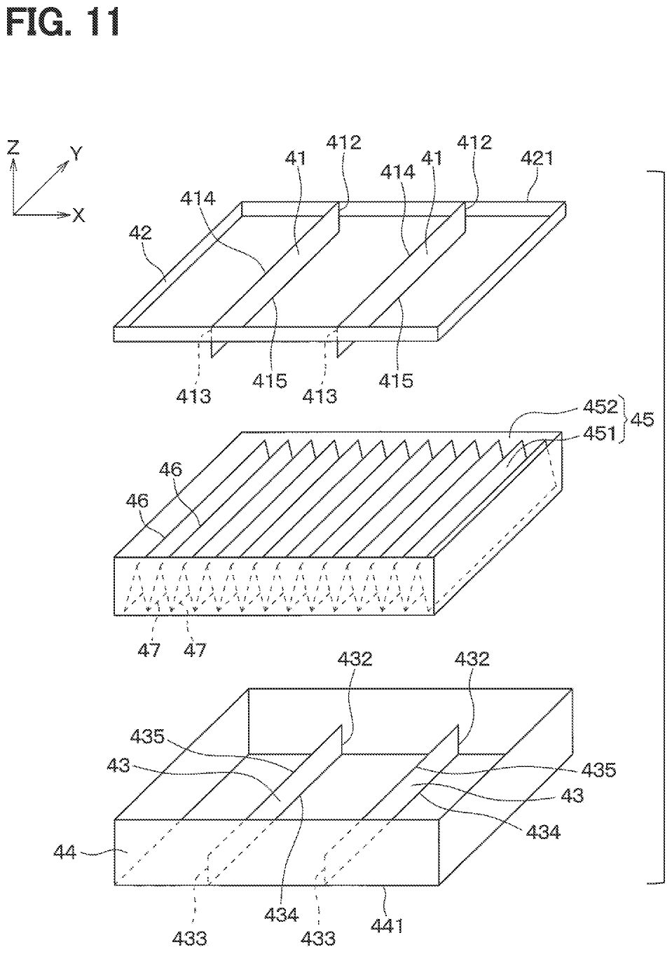

As shown in FIG. 10, in the third embodiment, the filter 40 is arranged so that the mountain ridge line 46 and the valley ridge line 47 formed on the filter medium 45 extend in the front-rear direction of the vehicle. The first partition plate 41 and the second partition plate 43 extend in the vehicle width direction intersecting the extending direction of the mountain ridge line 46 and the valley ridge line 47 formed in the filter medium 45.

In the third embodiment, the filter 40 is configured such that the extending direction of the mountain ridge line 46 and the valley ridge line 47 formed in the filter medium 45 intersects the extending direction of the first partition plate 41 and the second partition plate 43. Therefore, as described with reference to FIG. 4, the wavy portion 41 of the first partition plate 411 adjacent to the filter medium 45 has a corrugated shape (in other words, a jagged shape) corresponding to the corrugated shape of the filter medium 45. Therefore, the wavy portion 411 of the first partition plate 41 adjacent to the filter medium 45 enters each gap, e.g., the valley portion of the filter medium 45.

Further, the wavy portion 431 of the second partition plate 43 adjacent to the filter medium 45 also has a corrugated shape (in other words, a jagged shape) corresponding to the corrugated shape of the filter medium 45. Therefore, the wavy portion 431 of the second partition plate 43 adjacent to the filter medium 45 also enters each gap, e.g., the mountain portion of the filter medium 45.

### Fourth Embodiment

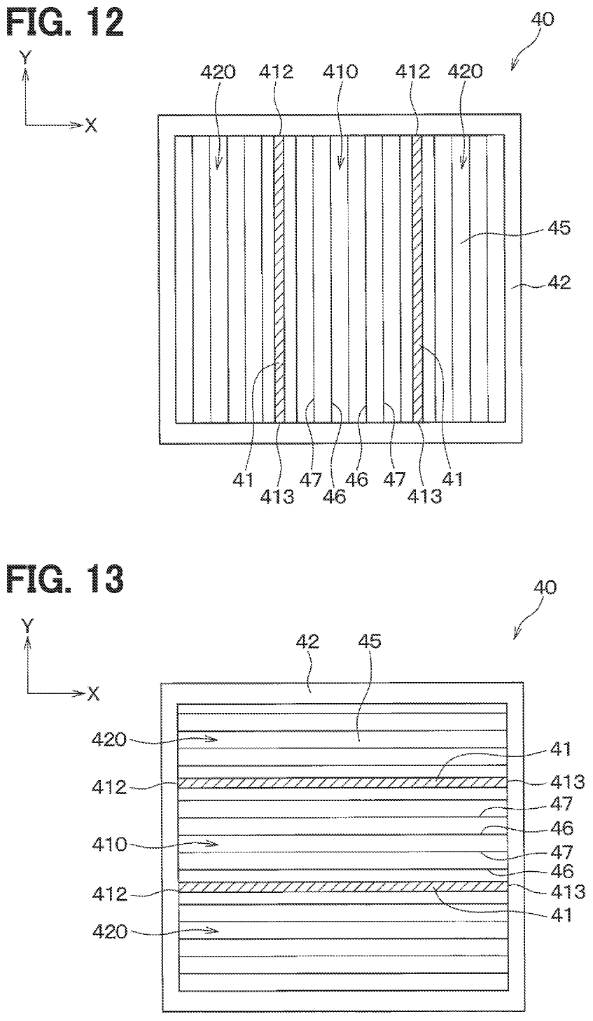

As shown in FIGS. 11 and 12, in the fourth embodiment, the filter 40 is arranged so that the mountain ridge line 46 and the valley ridge line 47 formed on the filter medium 45 extend in the front-rear direction of the vehicle. The first partition plate 41 and the second partition plate 43 extend in parallel with the extending direction of the mountain ridge line 46 and the valley ridge line 47 formed in the filter medium 45 (that is, in the front-rear direction of the vehicle). In FIG. 12, in order to make the first partition plate 41 easier to see, the first partition plate 41 is hatched, although it is not a cross section.

In the fourth embodiment, in the filter 40, the extending direction of the mountain ridge line 46 and the valley ridge line 47 formed in the filter medium 45 is the same as the extending direction of the first partition plate 41 and the second partition plate 43. Therefore, as shown in FIG. 11, the end portion 415 of the first partition plate 41 adjacent to the filter medium 45 is formed in a straight line. Further, the end portion 435 of the second partition plate 43 adjacent to the filter medium 45 is also formed in a straight line. The first partition plate 41 enters the gap of the valley portion formed in the filter medium 45. The second partition plate 43 enters the gap of the mountain portion formed in the filter medium 45.

In the fourth embodiment, the manufacturing cost can be reduced by simplifying the configurations of the first partition plate 41 and the second partition plate 43.

Further, in the fourth embodiment, the length of a portion of the first partition plate 41 and the second partition plate 43 adjacent to the filter medium 45 is shorter than that in the first to third embodiments, so that it is possible to improve the inside and outside air separation property.

### Fifth Embodiment

As shown in FIG. 13, in the fifth embodiment, the filter 40 is arranged so that the mountain ridge line 46 and the valley ridge line 47 formed on the filter medium 45 extend in the vehicle width direction. The first partition plate 41 and the second partition plate 43 extend in parallel (that is, in the vehicle width direction) with the extending direction of the mountain ridge line 46 and the valley ridge line 47 formed in the filter medium 45. Also in FIG. 13, in order to make the first partition plate 41 easier to see, the first partition plate 41 is hatched although it is not a cross section.

Also in the fifth embodiment, in the filter 40, the extending direction of the mountain ridge line 46 and the valley ridge line 47 formed in the filter medium 45 is the same as the extending direction of the first partition plate 41 and the second partition plate 43. Therefore, the end portion 415 of the first partition plate 41 adjacent to the filter medium 45 is formed in a straight line. Further, the end portion 435 of the second partition plate 43 adjacent to the filter medium 45 is also formed in a straight line. The first partition plate 41 enters the gap of the valley portion formed in the filter medium 45. The second partition plate 43 enters the gap of the mountain portion formed in the filter medium 45.

Similar to the fourth embodiment, the fifth embodiment can also reduce the manufacturing cost by simplifying the configurations of the first partition plate 41 and the second partition plate 43.

Further, in the fifth embodiment as well, as in the fourth embodiment, the length of a portion where the first partition plate 41 and the second partition plate 43 are adjacent to the filter medium 45 is shorter than that of the first to third embodiments, so that the inside/outside air separation property can be improved.

### Sixth to Eighth Embodiments

The sixth to eighth embodiments will be described. In the sixth to eighth embodiments, the shape and arrangement of the first partition plate 41 and the second partition plate 43 is modified with respect to the fourth embodiment and the fifth embodiment.

### Sixth Embodiment

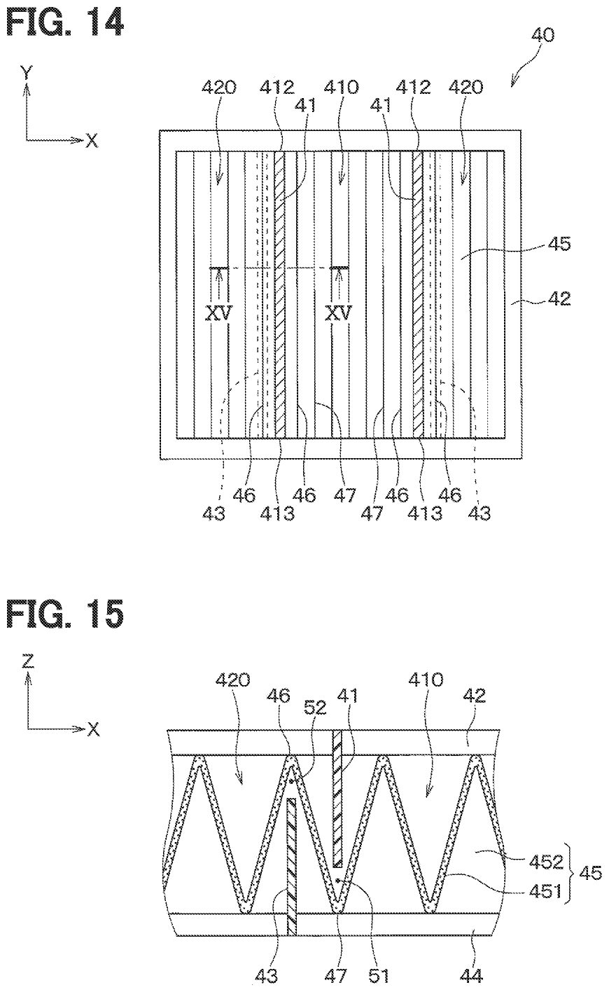

As shown in FIG. 14, the filter 40 of the sixth embodiment is configured that the extending direction of the mountain ridge line 46 and the valley ridge line 47 formed on the filter medium 45 is the same as the extending direction of the first partition plate 41 and the second partition plate 43. In FIG. 14, in order to make the first partition plate 41 easier to see, the first partition plate 41 is hatched, although it is not a cross section. Further, the second partition plate 43 is shown by a broken line.

As shown in FIG. 15, the first partition plate 41 of the filter 40 enters the gap 51 of the wavy shape formed in the filter medium 45, from the upper side to the lower side, which is a predetermined valley portion. On the other hand, the second partition plate 43 enters the gap 52 of the mountain portion adjacent to the predetermined valley portion into which the first partition plate 41 enters, from the lower side to the upper side. That is, the first partition plate 41 and the second partition plate 43 are provided at positions slightly deviated from each other when viewed in the axial direction Ax of the impeller 30. Even in such a configuration, it can be said that the first partition plate 41 and the second partition plate 43 are provided so as to sandwich the filter medium 45. Therefore, the filter 40 of the sixth embodiment can suppress the mixing of the air flowing through the central region 410 and the air flowing through the left and right regions 420.

### Seventh Embodiment

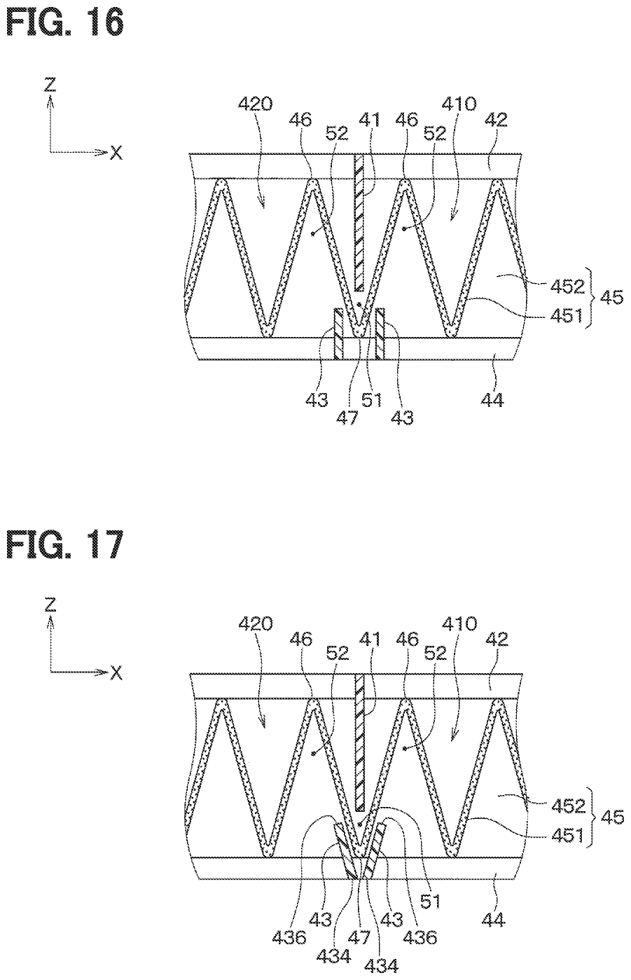

As shown in FIG. 16, in the seventh embodiment, the first partition plate 41 of the filter 40 is located in the gap 51 of the predetermined valley portion having a wavy shape formed on the filter medium 45 by being inserted from the upper side to the lower side. On the other hand, each of the two second partition plates 43 enters from the lower side to the upper side with respect to the gaps 52 of the mountain portions on both sides adjacent to the predetermined valley portion into which the first partition plate 41 enters. The first partition plate 41 and the two second partition plates 43 are provided at positions slightly offset from each other when viewed in the axial direction Ax of the impeller 30. However, the distance between the first partition plate 41 and the second partition plate 43 is set to be closer than the configuration described in the sixth embodiment when viewed from the axial direction Ax of the impeller 30. Therefore, the length of the second partition plate 43 in the vertical direction is shorter than the length of the first partition plate 41 in the vertical direction, corresponding to the shape of the filter medium 45. This restricts the filter medium 45 from being damaged by the second partition plate 43.

As described above, it can be said that also in the seventh embodiment, the first partition plate 41 and the two second partition plates 43 are provided so as to sandwich the filter medium 45. Therefore, even in the configuration of the filter 40 of the seventh embodiment, it is possible to suppress the mixing of the air flowing through the central region 410 and the air flowing through the left and right regions 420 of the filter 40.

### Eighth Embodiment

The eighth embodiment is a modification of the seventh embodiment. As shown in FIG. 17, in the eighth embodiment, the two second partition plates 43 are provided so as to have a V-shaped cross section corresponding to the shape of the filter medium 45. Specifically, the two second partition plates 43 are provided so as to extend from the lower end 434 to the upper end 436 of the second partition plate so that the distance between the two second partition plates 43 gradually increases. This restricts the filter medium 45 from being damaged by the second partition plate 43. Further, even in such a configuration, it can be said that the first partition plate 41 and the second partition plate 43 are provided so as to sandwich the filter medium 45. Therefore, even in the configuration of the filter 40 of the eighth embodiment, it is possible to suppress the mixing of the air flowing through the central region 410 and the air flowing through the left and right regions 420 of the filter 40.

### Ninth Embodiment

A ninth embodiment will be described hereafter. In the ninth embodiment, the configurations of the air introduction box 10, the separation cylinder 60, the filter 40, and the like are changed with respect to the first embodiment and the like. Only the parts different from the first embodiment and the like will be described, since the other parts are the same as those of the first embodiment and the like.

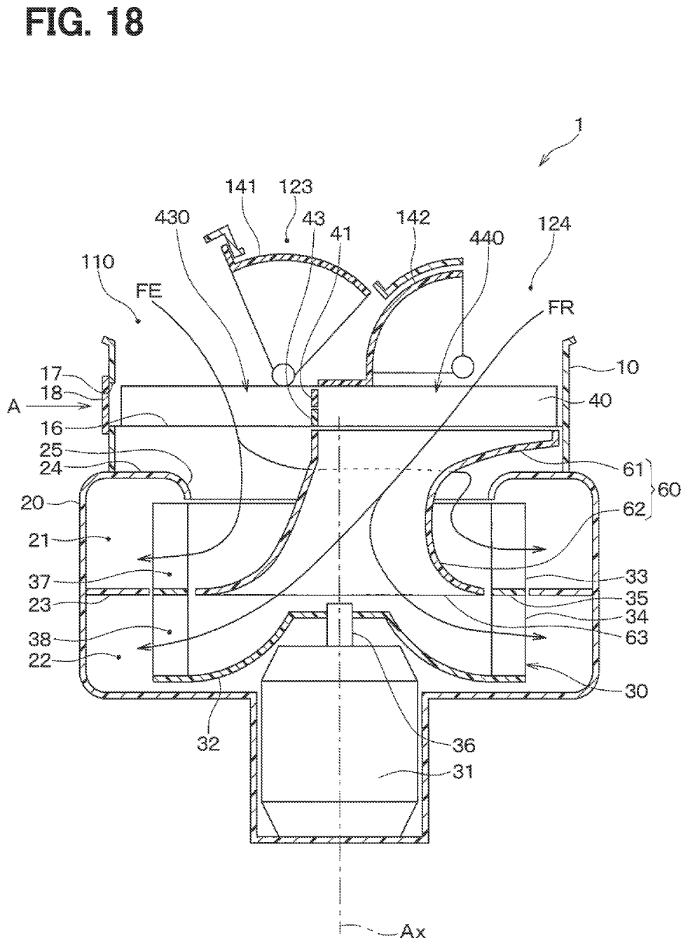

As shown in FIG. 18, the air introduction box 10 in the blower 1 of the ninth embodiment has an outside air introduction port 110, a first inside air introduction port 123, and a second inside air introduction port 124. A first inside/outside air door 141 and a second inside/outside air door 142 are provided in the air introduction box 10. Each of the first inside/outside air door 141 and the second inside/outside air door 142 is composed of a rotary door. The first inside/outside air door 141 selectively opens/closes the outside air introduction port 110 and the first inside air introduction port 123. The second inside/outside air door 142 opens/closes the second inside air introduction port 124. Further, the second inside/outside air door 142 selectively causes the second region 440 of the filter 40 (for example, the region on the right side of the filter 40 shown in FIG. 18) to communicate with the second inside air introduction port 124 or the outside air introduction port 110.

The filter 40 is installed in the filter installation portion 16 provided in the air introduction box 10. The filter installation portion 16 is configured to install the filter 40 inside the air introduction box 10.

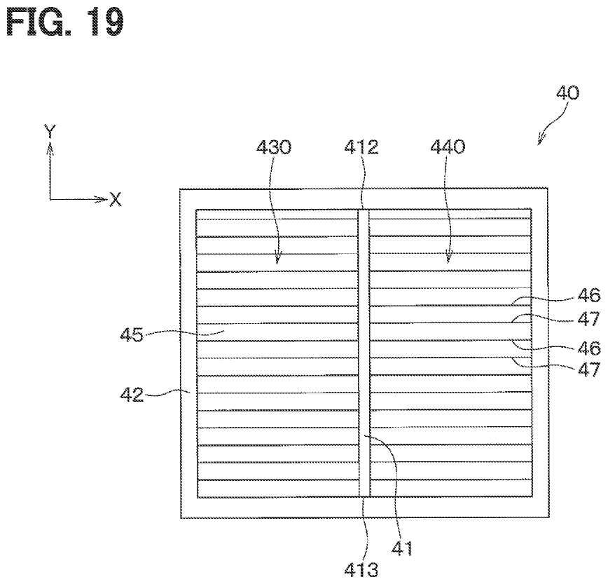

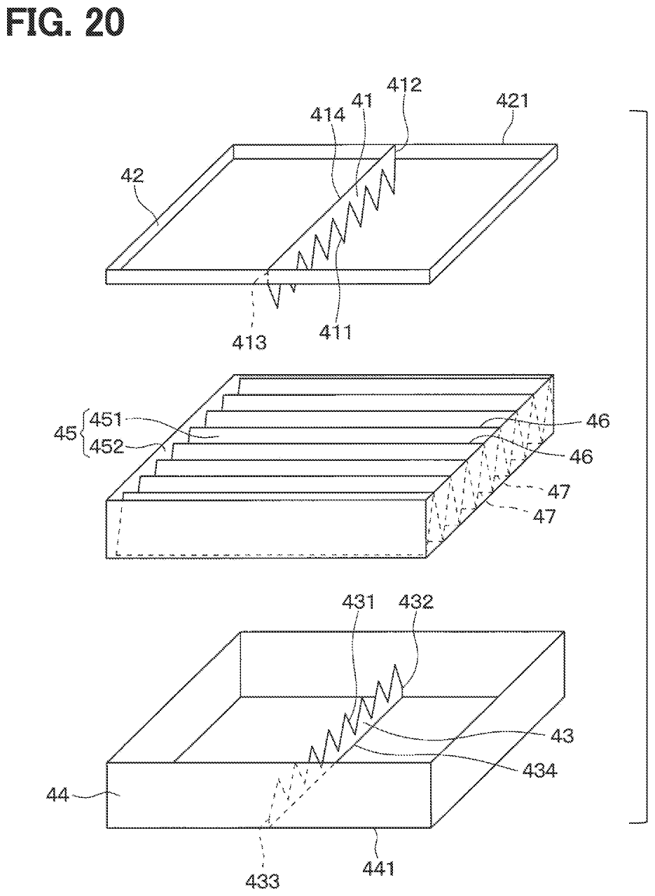

As shown in FIGS. 19 and 20, the filter 40 includes a first frame body 42 to which the first partition plate 41 is fixed, a second frame body 44 to which the second partition plate 43 is fixed, and a filter medium 45.

In the filter 40 of the ninth embodiment, one first partition plate 41 is arranged on the upstream side of the filter medium 45. The wavy portion 411 of the first partition plate 41 adjacent to the filter medium 45 has a corrugated shape (in other words, a jagged shape) corresponding to the corrugated shape of the filter medium 45. Therefore, the wavy portion 411 of the first partition plate 41 adjacent to the filter medium 45 can enter each gap of the valley portion of the filter medium 45.

Further, in the filter 40, one second partition plate 43 is arranged on the downstream side of the filter medium 45. The wavy portion 431 of the second partition plate 43 adjacent to the filter medium 45 also has a corrugated shape (in other words, a jagged shape) corresponding to the corrugated shape of the filter medium 45. Therefore, the wavy portion 431 of the second partition plate 43 adjacent to the filter medium 45 can enter each gap of the mountain portion of the filter medium 45.

The second partition plate 43 is provided at a position corresponding to the first partition plate 41. Specifically, the second partition plate 43 and the first partition plate 41 are provided at positions where they overlap each other when viewed from the axial direction Ax of the impeller 30. The filter medium 45 is interposed between the first partition plate 41 and the second partition plate 43. The second partition plate 43 and the first partition plate 41 may be provided at positions slightly offset from each other when viewed in the axial direction Ax of the impeller 30.

Thereby, the first partition plate 41 and the second partition plate 43 can divide the space inside the first frame body 42 and the second frame body 44 into two regions. In the following description, in the filter 40 shown in FIGS. 18 to 20, the space inside the first frame body 42 and the second frame body 44 is partitioned by the first partition plate 41 and the second partition plate 43 into a first region 430 which is an area on the left side and a second region 440 which is an area on the right side.

As shown in FIG. 18, a separation cylinder 60 is provided on the downstream side of the filter 40. The separation cylinder 60 of the ninth embodiment also has the air collecting portion 61 and the tubular portion 62 integrally. The air collecting portion 61 is arranged between the filter 40 and the bell mouth 25. The air collecting portion 61 is arranged at a position corresponding to the second region 440 of the filter 40, and introduces the air that has passed through the second region 440 of the filter 40 into the inner flow path of the tubular portion 62.

The tubular portion 62 is integrally formed with the air collecting portion 61 and is arranged inside the impeller 30. The tubular portion 62 is arranged inside the impeller 30 at a position shifted to one side in the radial direction. The tubular portion 62 is formed in a flare shape that gradually expands radially outward as it approaches the air outlet portion 63. The outer edge of the tubular portion 62 adjacent to the air outlet portion 63 is provided at a position corresponding to the separation plate 35 of the impeller 30.

The blower 1 of the ninth embodiment also has as an air suction mode, such as an inside/outside air two-layer mode in which the outside air and the inside air are simultaneously sucked in and separately blown out, an outside air mode in which the outside air is sucked in and blown out, or an inside air mode in which the inside air is sucked in and blown out.

FIG. 18 shows a state in which the inside/outside air two-layer mode is set in the blower 1. At that time, the first inside/outside air door 141 opens the outside air introduction port 110 and closes the first inside air introduction port 123. The second inside/outside air door 142 communicates the second inside air introduction port 124 with the second region 440 of the filter 40. When the impeller 30 rotates in this state, the outside air is introduced from the outside air introduction port 110, and the inside air is introduced from the second inside air introduction port 124.

As shown by the arrow FE in FIG. 18, the outside air introduced from the outside air introduction port 110 passes through the first region 430 of the filter 40, flows through the flow path outside the separation cylinder 60, and is sucked into the first blade flow path 37 of the impeller 30 so as to be blown out to the first ventilation passage 21.

As shown by the arrow FR in FIG. 18, the inside air introduced from the second inside air introduction port 124 passes through the second region 440 of the filter 40, flows through the flow path inside the separation cylinder 60, and is sucked into the second blade flow path 38 of the impeller 30 so as to be blown out to the second ventilation passage 22.

Although not shown, in the blower 1, when the outside air mode is set, the first inside/outside air door 141 and the second inside/outside air door 142 are displaced as follows. The first inside/outside air door 141 opens the outside air introduction port 110 and closes the first inside air introduction port 123. The second inside/outside air door 142 closes the second inside air introduction port 124. Therefore, the second region 440 of the filter 40 communicates with the outside air introduction port 110 through the space inside the air introduction box 10. When the impeller 30 rotates in that state, outside air is introduced from the outside air introduction port 110.

The outside air introduced from the outside air introduction port 110 and that has passed through the first region 430 of the filter 40 flows through the flow path outside the separation cylinder 60 and is sucked into the first blade flow path 37 of the impeller 30 so as to be blown out to the first ventilation passage 21. Further, the outside air introduced from the outside air introduction port 110 and that has passed through the second region 440 of the filter 40 flows through the flow path inside the separation cylinder 60 and is sucked into the second blade flow path 38 of the impeller 30 so as to be blown out to the second ventilation passage 22.

Further, in the blower 1, when the inside air mode is set, the first inside/outside air door 141 and the second inside/outside air door 142 are displaced as follows. The first inside/outside air door 141 closes the outside air introduction port 110 and opens the first inside air introduction port 123. The second inside/outside air door 142 communicates the second inside air introduction port 124 with the second region 440 of the filter 40. When the impeller 30 rotates in that state, the inside air is introduced from the first inside air introduction port 123 and the second inside air introduction port 124.

The inside air introduced from the first inside air introduction port 123 passes through the first region 430 of the filter 40, flows through the flow path outside the separation cylinder 60, and is sucked into the first blade flow path 37 of the impeller 30 so as to be blown out to the first ventilation passage 21. Further, the inside air introduced from the second inside air introduction port 124 flows through the flow path inside the separation cylinder 60 via the second region 440 of the filter 40, and is sucked into the second blade flow path 38 of the impeller 30 so as to be blown out to the second ventilation passage 22.

The filter 40 of the ninth embodiment can also have the same effect as that of the first embodiment and the like.

That is, the number of the first partition plate 41 and the second partition plate 43 provided in the filter 40 can be arbitrarily set according to the configuration of the blower 1. Thereby, the space through which the air flows in the filter 40 can be divided into an arbitrary number of regions.

### Other Embodiments

The present disclosure is not limited to the embodiments described above, and can be modified as appropriate. The above embodiments are not independent of each other, and can be appropriately combined except when the combination is obviously impossible. Further, in each of the above-mentioned embodiments, it goes without saying that components of the embodiment are not necessarily essential except for a case in which the components are particularly clearly specified as essential components, a case in which the components are clearly considered in principle as essential components, and the like. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. In each of the above embodiments, when the shapes, positional relationships, and the like of the components and the like are referred to, the shapes, positional relationships, and the like are not limited thereto unless otherwise specified or limited to specific shapes, positional relationships, and the like in principle.

(1) In each of the embodiments, the height of the first frame body 42 is smaller than the height of the second frame body 44, but is not limited to this in the filter 40. For example, the height of the first frame body 42 may be set larger than the height of the second frame body 44. Alternatively, the height of the first frame body 42 may be the same as the height of the second frame body 44.

(2) In the second embodiment, the frame body 48 and the first partition plate 41 are connected via the hinge 49, but are not limited to. The filter 40 may be configured such that the frame body 48 and the second partition plate 43 are connected via the hinge 49. Alternatively, the filter 40 may have a configuration in which the frame body 48 and the first partition plate 41 are connected via the hinge 49, and the frame body 48 and the second partition plate 43 are also connected via the hinge 49.

(3) In each of the embodiments, the scroll casing 20 is arranged on the downstream side of the air introduction box 10, and the impeller 30 and the like are disposed therein, but not limited to. The casing arranged on the downstream side of the air introduction box 10 may have ventilation passage 21, 22 having a shape different from the scroll.

(4) In each of the embodiments, the blower 1 is applied to a vehicle air conditioner, but is not limited to. The blower 1 may be applied to a device other than the vehicle air conditioner.

(5) In each of the embodiments, the first air is referred to as outside air and the second air is referred to as inside air, but not limited to. The first air may be inside air and the second air may be outside air. Alternatively, various gases having different humidity, temperature, composition, etc. may be adopted as the first air and the second air.

According to the first aspect shown in part or all of the embodiments, a blower capable of simultaneously sucking in a first air and a second air and separately blowing them out includes an air introduction box, a casing, an impeller, a frame body, a filter medium, a first partition plate and a second partition plate. The air introduction box has a first introduction port into which the first air is introduced and a second introduction port into which the second air is introduced. The casing forms a ventilation path through which air flows together with the air introduction box. The impeller is housed in the casing to suck in the first air and the second air introduced into the air introduction box, and to blow them out to the first air passage and the second air passage formed on the downstream side of the impeller. The filter medium captures a foreign matter contained in the first air and the second air flowing from the air introduction box to the impeller. The frame body houses the filter medium and is installed at a filter installation portion provided on the upstream side of the impeller. The first partition plate is fixed to the frame body and divides the space upstream side of the filter medium into a plurality of regions. The second partition plate is fixed to the frame body, and divides the space downstream side of the filter medium into a plurality of regions. The filter medium is interposed between the first partition plate and the second partition plate.

According to the second aspect, when the upstream end of the first partition plate is referred to as the first partition plate upper end and the upstream end of the frame is referred to as the frame upper end, the first partition plate upper end is arranged at the same position as the frame upper end, or is arranged adjacent to the filter medium than the frame upper end. Further, when the downstream end of the second partition plate is referred to as the second partition plate lower end and the downstream end of the frame is referred to as the frame lower end, the second partition plate lower end is arranged at the same position as frame lower end, or is arranged adjacent to the filter medium than the frame lower end.

Accordingly, the first partition plate upper end does not protrude to the upstream side from the frame upper end, and the second partition plate lower end does not protrude to the downstream side from the frame lower end in the filter constructed by the frame body, the filter medium, the first partition plate, and the second partition plate. Therefore, when the filter is attached to and detached from the filter installation portion through the opening provided in the outer wall of the air introduction box, the first partition plate or the second partition plate can be restricted from interfering with the wall around the opening. Therefore, it is easy to attach/detach the filter to/from the blower.

According to the third aspect, the frame body includes a first frame arranged adjacent to the first introduction port or the second introduction port, and a second frame arranged adjacent to the separation cylinder. The first frame and the first partition plate are fixed with each other, and the second frame and the second partition plate are fixed with each other.

Accordingly, the filter medium is sandwiched between the first partition plate fixed to the first frame and the second partition plate fixed to the second frame. Therefore, the first partition plate and the second partition plate can be reliably positioned, and it is easy to attach/detach the filter to/from the blower.

According to the fourth aspect, the first frame and the first partition plate are integrally formed, and the second frame and the second partition plate are integrally formed.

Accordingly, the first frame and the first partition plate are integrally formed by resin injection molding or the like, and the second frame and the second partition plate are integrally formed by resin injection molding or the like. The manufacturing process can be simplified and the manufacturing cost can be reduced.

According to the fifth aspect, the first frame and the second frame are fixed by fitting, and the relative movement is restricted in a direction intersecting the overlap direction in which the first frame and the second frame overlap each other.

Accordingly, it is possible to easily assemble the first frame, the second frame, and the filter medium, and it is possible to restrict the positional deviation between the first frame and the second frame.

According to the sixth aspect, at least one of the first partition plate and the second partition plate is connected to the frame body via a hinge.

Accordingly, the number of parts can be reduced, and the frame body and the filter medium can be easily assembled. Further, when the first partition plate and the second partition plate are fixed to one frame body, it is possible to restrict the positional deviation between the first partition plate and the second partition plate.

According to the seventh aspect, the first partition plate is composed of one or a plurality of parts. Further, the second partition plate is composed of one or a plurality of parts corresponding to the first partition plate.

Accordingly, it is possible to divide the space through which the air flows in the filter into an arbitrary number of regions according to the configuration of the blower.

According to the eighth aspect, a filter device provided in the ventilation path through which the first air and the second air flow includes a frame body, a filter medium, a first partition plate, and a second partition plate. The frame body constitutes the outer frame of the filter device. The filter medium is housed inside the frame body to capture a foreign matter contained in the first air and the second air flowing through the ventilation path. The first partition plate is fixed to the frame body and divides the space on the upstream side of the filter medium into a plurality of regions. The second partition plate is fixed to the frame body and divides the space on the downstream side of the filter medium into a plurality of regions. The filter medium is interposed between the first partition plate and the second partition plate.

Accordingly, in the filter device of the eighth aspect as well as the filter provided in the blower of the first aspect, each of the first partition plate and the second partition plate is fixed to the frame body, so that the partition plates can be positioned easily and reliably. Therefore, the misalignment between the first partition plate and the second partition plate can be restricted. Therefore, this filter device can suppress the mixing of the first air and the second air.

What is claimed is:

1. A blower configured to simultaneously suck in and separately blow out a first air and a second air, the blower comprising:
an air introduction box having a first introduction port into which the first air is introduced and a second introduction port into which the second air is introduced;
a casing that forms a ventilation path through which air flows together with the air introduction box;
an impeller housed in the casing to suck in the first air and the second air introduced into the air introduction box and blow out to a first air passage and a second air passage downstream of the impeller;
a filter medium configured to capture a foreign matter contained in the first air and the second air flowing from the air introduction box to the impeller;
a frame body that houses the filter medium and is installed in a filter installation portion upstream of the impeller;
a first partition plate fixed to the frame body to divide a space upstream of the filter medium into a plurality of regions; and
a second partition plate fixed to the frame body to divide a space downstream of the filter medium into a plurality of regions, wherein the filter medium is interposed between the first partition plate and the second partition plate.

2. The blower according to claim 1, wherein
an upstream end of the first partition plate is referred to as a first partition plate upper end,
an upstream end of the frame body is referred to as a frame upper end,
the first partition plate upper end is arranged at a same position as the frame upper end, or is located adjacent to the filter medium than the frame upper end is,
a downstream end of the second partition plate is referred to as a second partition plate lower end,
a downstream end of the frame body is referred to as a frame lower end, and
the second partition plate lower end is arranged at a same position as the frame lower end, or is located adjacent to the filter medium than the frame lower end is.

3. The blower according to claim 1, wherein
the frame body includes a first frame arranged adjacent to the first introduction port or the second introduction port, and a second frame arranged adjacent to the impeller,
the first frame and the first partition plate are fixed with each other, and
the second frame and the second partition plate are fixed with each other.

4. The blower according to claim 3, wherein
the first frame and the first partition plate are integrally formed with each other, and
the second frame and the second partition plate are integrally formed with each other.

5. The blower according to claim 3, wherein
the first frame and the second frame are fixed with each other by fitting so as to restrict a relative movement in a direction intersecting an overlap direction in which the first frame and the second frame overlap each other.

6. The blower according to claim 1, wherein at least one of the first partition plate and the second partition plate is connected to the frame body through a hinge.

7. The blower according to claim 1, wherein
the first partition plate is composed of at least one component, and
the second partition plate is composed of at least one component corresponding to the first partition plate.

8. A filter device provided in a ventilation path through which a first air and a second air flow, the filter device comprising:
a frame body constituting an outer frame of the filter device;
a filter medium housed inside the frame body to capture a foreign matter contained in the first air and the second air flowing through the ventilation path;
a first partition plate fixed to the frame body and dividing a space upstream of the filter medium into a plurality of regions; and
a second partition plate fixed to the frame body and dividing a space downstream of the filter medium into a plurality of regions, wherein
the filter medium is interposed between the first partition plate and the second partition plate.
